(19) United States
(12) Patent Application Publication
(10) Pub. No.: US 2025/0273201 A1
(43) Pub. Date: Aug. 28, 2025

(54) LEARNING DEVICE AND LEARNING METHOD

(71) Applicant: SONY GROUP CORPORATION, TOKYO (JP)

(72) Inventors: YUHEI TAKI, TOKYO (JP); KUNIHITO SAWAI, TOKYO (JP); MASAKI TAKASE, TOKYO (JP); AKIRA MIYASHITA, TOKYO (JP)

(21) Appl. No.: 18/857,634

(22) PCT Filed: Apr. 11, 2023
(86) PCT No.: PCT/JP2023/014652

§ 371 Date: Oct. 17, 2024

(30) Foreign Application Priority Data
Apr. 26, 2022 (JP) 2022-072408

(51) Int. Cl. G10L 15/06; G10L 15/22

(52) U.S. Cl. CPC G10L 15/063; G10L 15/22; G10L 2015/223

(57) ABSTRACT

A learning device (100) according to an aspect of the present disclosure includes: an acquisition unit (131) that acquires a content of a command input by a user to a predetermined information processing system; and a learning unit (132) that in a case where it is determined that the command includes an unrecognizable target, learns recognition information for recognizing the target on the basis of operation of the information processing system by the user or a use history of the information processing system.

### FIELD

The present disclosure relates to a learning device and a learning method that spontaneously learn information such as a call for specifying a predetermined target.

### BACKGROUND

In interaction between users via a network, each user is specified by a handle name, an account name, or the like. Furthermore, each user can also set a nickname as information for specifying the user himself/herself. For example, a user calls a nickname of other user with whom the user wants to interact, or inputs the nickname by text to specify that other user, and performs voice chat or message transmission.

In this regard, a conversation system has been proposed enabling what a given name uttered by a user during conversation indicates to be accurately determined and an appropriate answer to be returned by using a voice recognition technique (e.g., Patent Literature 1).

### CITATION LIST

### Patent Literature

Patent Literature 1: JP 2004-334591 A

### SUMMARY

### Technical Problem

According to a conventional technique, it is possible to determine a person corresponding to a call uttered by a user and specify the utterance as that for the determined person, so that conversation can be smoothly advanced.

However, when a series of meaningless alphabets or a language unfamiliar to each other is used in identification information for specifying a user, a user may not be able to specify other users on the network. For example, since a user cannot pronounce a nickname including a series of unpronounceable characters, or an account name using unreadable characters, there is a possibility that the user is forced to take time and effort to search for a desired partner from a friend list or gives up interaction.

Therefore, the present disclosure relates to a learning device and a learning method that enable easy setting of information for specifying a predetermined target.

### Solution to Problem

A learning device according to one embodiment of the present disclosure includes: an acquisition unit that acquires a content of a command input by a user to a predetermined information processing system; and a learning unit that in a case where it is determined that the command includes an unrecognizable target, learns recognition information for recognizing the target on the basis of operation of the information processing system by the user or a use history of the information processing system.

### BRIEF DESCRIPTION OF DRAWINGS

FIG. 1 is a diagram illustrating an overview of learning processing according to an embodiment.

FIG. 2 is a diagram illustrating an example (1) of the learning processing according to the embodiment.

FIG. 3 is a diagram illustrating an example (2) of the learning processing according to the embodiment.

FIG. 4 is a diagram illustrating an example (3) of the learning processing according to the embodiment.

FIG. 5 is a diagram illustrating a configuration example of a learning device according to the embodiment.

FIG. 6 is a diagram illustrating an example of a user storage unit according to the embodiment.

FIG. 7 is a diagram illustrating an example of an application storage unit according to the embodiment.

FIG. 8 is a diagram illustrating an example of an association storage unit according to the embodiment.

FIG. 9 is a flowchart (1) illustrating a flow of the learning processing according to the embodiment.

FIG. 10 is a flowchart (2) illustrating a flow of the learning processing according to the embodiment.

FIG. 11 is a flowchart (3) illustrating a flow of the learning processing according to the embodiment.

FIG. 12 is a hardware configuration diagram illustrating an example of a computer that implements functions of the learning device.

### DESCRIPTION OF EMBODIMENTS

In the following, embodiments will be described in detail with reference to the drawings. In each of the following embodiments, the same parts are denoted by the same reference numerals to omit redundant description.

The present disclosure will be described according to the following order of items.
1. Embodiment
1-1. Overview of Learning Processing according to Embodiment
1-2. Configuration of Learning Device according to Embodiment
1-3. Procedure of Learning Processing according to Embodiment
1-4. Modification
1-4-1. Device Configuration
1-4-2. Learning Result
1-4-3. Input to System
2. Other Embodiments
3. Effects of Learning Device according to Present Disclosure
4. Hardware Configuration

### 1. Embodiment

### 1-1. Overview of Learning Processing According to Embodiment

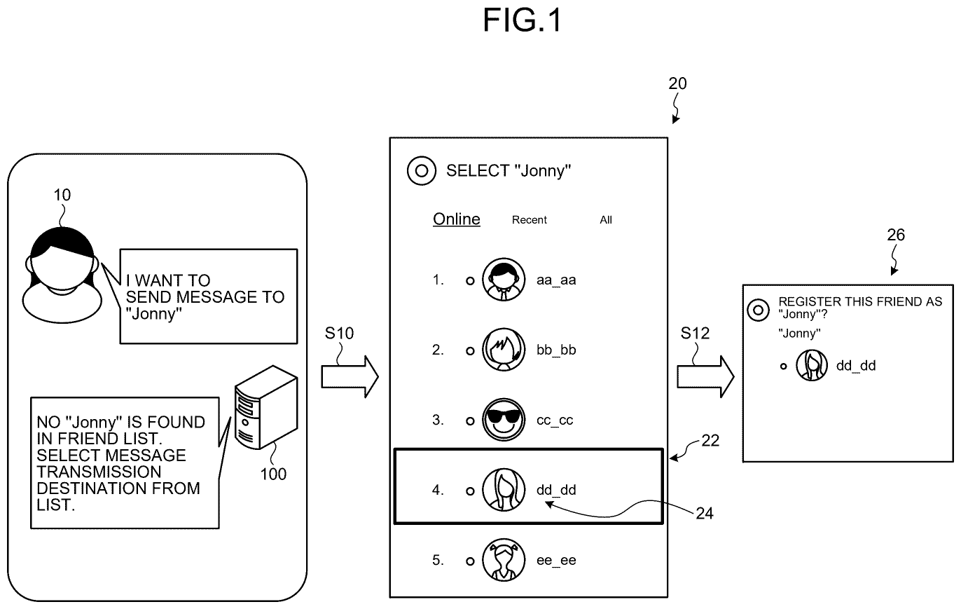

FIG. 1 is a diagram illustrating an overview of learning processing according to an embodiment. The learning processing according to the embodiment is realized by a learning device 100 illustrated in FIG. 1.

The learning device 100 is an example of an information processing device that executes the learning processing according to the embodiment. For example, the learning device 100 is a cloud server, a personal computer (PC), a smartphone, a tablet terminal, or the like connected to a network. Note that the learning device 100 may be any information apparatus having a function to be described later, such as a smart home appliance such as a television, a video game console such as a game machine, or the like. In the example of FIG. 1, the learning device 100 is an information processing device including a voice agent capable of uttering with a user 10, and is capable of displaying various types of information on a connected display.

The user 10 is a user who uses an information processing system provided by the learning device 100. The system provided by the learning device 100 has, for example, a function as a so-called operating system (OS) that operates an installed game application, video viewing application, or the like, and controls message transmission to and a chat function with other users. The user 10 uses a voice recognition function of the learning device 100 to utter various instructions (hereinafter referred to as “voice command”) such as “Open a game application” and “I want to transmit a message to other user”, thereby starting an application or interacting with other user. Note that in the following description, there is a case where a user who is a subject that causes learning, such as causing the learning device 100 to learn a call, is referred to as the “user 10” and is distinguished from other users connected to the user 10 via a network.

In general, a game application or the like using a network is designed so that the user 10 can actively interact with other users. For example, the user 10 can enjoy online play with other users, exchange messages and chats with other users, and share a game screen. Other users with whom the user 10 can interact are listed and displayed to enable looking-through, for example, in a case of an online state in which the user is logged in a game application. Such a list is referred to as a friend list or the like.

The user 10 can select other user from the friend list and interact with such other user. Furthermore, the user 10 can communicate with other user whose name is remembered by calling the name of such other user without taking time and effort to select the name from the friend list.

However, in a situation where users in the world are connected via a network, it may be difficult for the user 10 to specify other users. For example, in order to maintain anonymity, a user connected to a network may make a name for identifying the user himself or herself such as a handle name, an account name, or a nickname (hereinafter, collectively referred to as “ID”) into a series of meaningless characters. Alternatively, some users connected to the network may set their own ID using characters unfamiliar to other users.

Even with a series of meaningless characters, when the user 10 makes a sound, while the learning device 100 can compare and collate a voice-recognized text with an ID, specifying other users is not always successful. In other words, in a case where the ID is different from a call expected by the user 10, a voice command using the call expected by the user 10 cannot be executed. In this case, the user 10 needs to take extra time and effort to select a target of interest with reference to the friend list. In other words, in the use of the system, there is a need to directly designate a target by voice even in a case where a call is unknown when specifying a certain target.

Therefore, the learning device 100 according to the present disclosure solves the above problem by learning processing to be described below. Specifically, the learning device 100 acquires a content of a command input by the user 10 to a predetermined system. Then, in a case where it is determined that an unrecognizable target is included in the acquired command, the learning device 100 learns recognition information for recognizing a target on the basis of operation of the system by the user 10 or a use history of the system. For example, the learning device 100 automatically sets a call to a target by learning an appropriate call at appropriate timing without the user 10 taking trouble to set some kind of call. As a result, the user 10 can easily set information for specifying a predetermined target while reducing a load of manually performing some setting.

The overview of the learning processing according to the embodiment will be described below along the flow illustrated in FIG. 1. In the example of FIG. 1, the user 10 inputs, to the learning device 100, a voice command for requesting sending of a message to “Jonny” who is a friend with whom the user has met before.

In this example, “Jonny” is, for example, a call made by a friend and heard by the user 10 and is not an accurate spelling or something that is not registered as an ID of the friend.

When acquiring the voice command input by the user 10, the learning device 100 analyzes the voice command on the basis of a known voice recognition technique. For example, the learning device 100 recognizes that a content of the voice command is “message transmission” and a target (referred to as an entity) that is a transmission destination is “Jonny”.

The learning device 100 searches for “Jonny” from the friend list stored in the system. For example, the learning device 100 verifies whether the ID registered in the friend list matches “Jonny” or not. Then, in a case where a user having the ID “Jonny” cannot be searched, the learning device 100 determines that the voice command includes an unrecognizable target. In this case, the learning device 100 issues a message that “No “Jonny” is found in the friend list. Select a message transmission destination from the list.” to the user 10. In other words, since “Jonny” cannot be searched from pronunciation, the learning device 100 proceeds to processing of presenting the friend list to the user 10 and allowing the user 10 to select “Jonny” from the friend list (Step S10).

A friend list 20 illustrated in FIG. 1 is displayed on, for example, a display connected to the learning device 100. The user 10 browses the friend list 20, and recognizes that a user 24 is “Jonny”, which is a message transmission target, among the other presented users. In this case, the user 10 uses an arbitrary means for input (keyboard, mouse, game controller, etc.) to the learning device 100 or pronounces a number of the list (“4” in the example of FIG. 1), thereby aligning a selection cursor 22 with the user 24 to select the user 24.

In response to the user 24 being specified by the user 10, the learning device 100 proceeds to processing for learning the user 24 as “Jonny” (Step S12).

For example, as illustrated in a learning screen 26, the learning device 100 asks the user 10: “Register this friend as “Jonny”?” In a case of desiring to register the user 24 as a call “Jonny”, the user 10 makes a sound to the effect that the setting is to be accepted. In this case, the learning device 100 stores the user 24 and spelling of “Jonny” or pronunciation of “Jonny” (voice data or the like) in association with each other. As a result, when the user 10 next pronounces “Jonny”, the learning device 100 can recognize that “Jonny” is the user 24.

As described above, in a case where it is determined that the voice command includes an unrecognizable target (“Jonny” in the example of FIG. 1), the learning device 100 learns recognition information (“Jonny”) for recognizing the target on the basis of operation (selection by the user 24 in the example of FIG. 1) of the system by the user 10. In this example, “Jonny” uttered by the user 10 is likely to be a call that the user 10 wants to use to specify the user 24. Therefore, the learning device 100 can execute a voice command with a call expected by the user 10 from the next time by learning such a call. As a result, the user 10 can set, as a target, a call desired by the user himself/herself without a load.

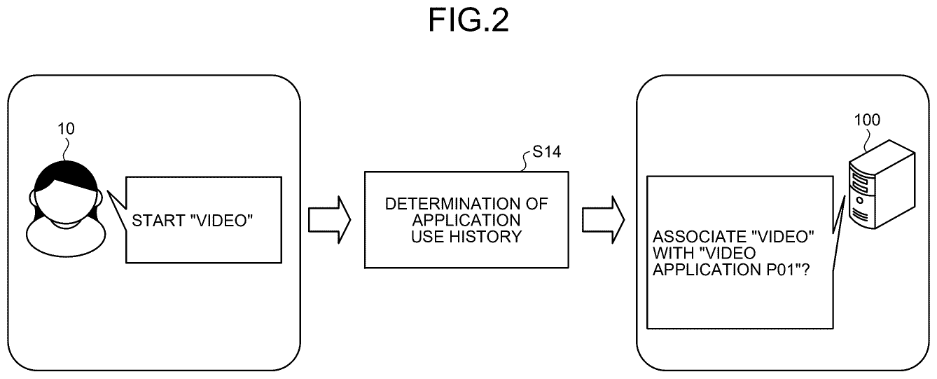

Note that although FIG. 1 illustrates the example in which the user 10 sets a call of a friend as a target of a voice command, the learning processing according to the embodiment is applicable to various targets. Such aspect will be described with reference to FIGS. 2 to 4.

FIG. 2 is a diagram (1) illustrating an example of the learning processing according to the embodiment. In the example of FIG. 2, the user 10 inputs a voice command “Start “video”.” to the learning device 100.

When the “video” in the acquired voice command is unrecognizable, the learning device 100 refers to an application use history of the user 10 in the system and searches for a target corresponding to “video” (Step S14).

For example, in a case where the user 10 issues a voice command for starting a certain program (application) such as “Start “video”.” or “Open “video”.”, the learning device 100 refers to an action history immediately after the issuance. Then, after issuing the voice command, the learning device 100 determines that the user 10 tends to start a video application, for example, when the user has started a video application P01 a predetermined number of times or more.

In this case, the learning device 100 determines that the “video” uttered by the user 10 aims at the “video application P01”, and attempts to associate such contents with each other. For example, the learning device 100 outputs a message “Associate “video” with “video application P01”?” to the user 10 and waits for a response from the user 10. When the user 10 accepts that the “video” is associated with the “video application P01”, the learning device 100 learns to read “video” as the “video application P01” in a predetermined voice command. As a result, the user 10 can start the application with his or her desired call.

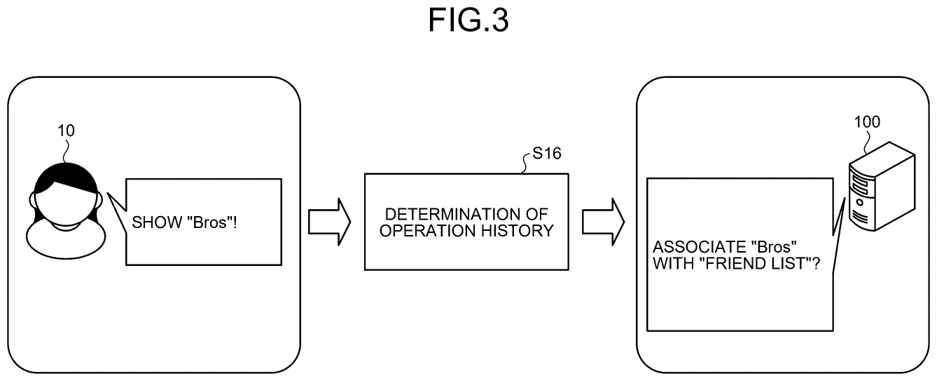

Other example will be described with reference to FIG. 3. FIG. 3 is a diagram (2) illustrating an example of the learning processing according to the embodiment. In the example of FIG. 3, the user 10 inputs a voice command “Show “Bros”!” to the learning device 100.

In a case where “Bros” in the acquired voice command is unrecognizable, the learning device 100 refers to an operation history of the user 10 in the system and searches for a target corresponding to “Bros” (Step S16).

For example, the learning device 100 refers to an operation history immediately after the user 10 issues a voice command for performing a certain action, such as “Show me “Bros”.” or “I want to send a message to “Bros”.” Then, after issuing the voice command, the learning device 100 determines that the user 10 tends to execute an action mainly related to the friend list, such as referring to the friend list or searching into the friend list.

In this case, the learning device 100 determines that the “Bros” uttered by the user 10 aims at a “friend list” (or a friend), and attempts to associate such contents with each other. For example, the learning device 100 outputs a message “Associate “Bros” with “friend list”?” to the user 10 and waits for a response from the user 10. When the user 10 accepts that the “Bros” is associated with the “friend list”, the learning device 100 learns to read the “Bros” as the “friend list” in a predetermined voice command. As a result, the user 10 can read the name on the system such as the friend list with his/her desired call.

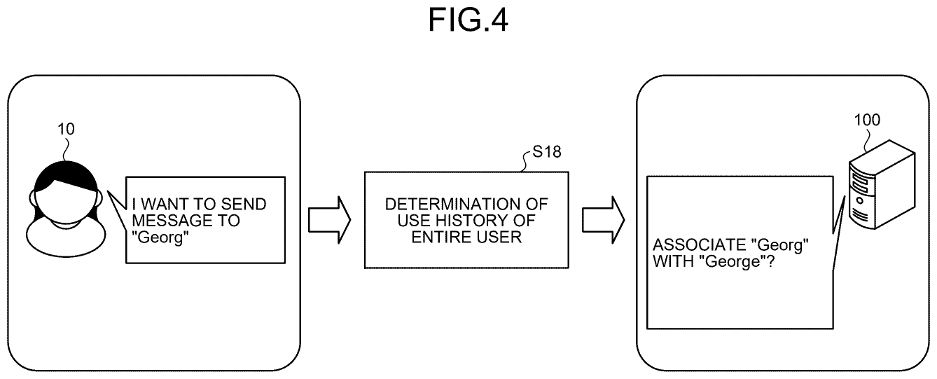

Other example will be described with reference to FIG. 4. FIG. 4 is a diagram (3) illustrating an example of the learning processing according to the embodiment. In the example of FIG. 4, the user 10 inputs a voice command “I want to send a message to “Georg”.” to the learning device 100.

In a case where “Georg” in the acquired voice command is unrecognizable, or in a case where it is determined that there is a possibility that other word is associated with “Georg” in the system, the learning device 100 determines a use history of the entire user who uses the system (Step S18). Note that the entire user who uses the system means, for example, an unspecified number of users who use the system provided by the learning device 100 and can acquire the use history via the network.

For example, the learning device 100 refers to the use history of the entire user, and refers to that the user who uses the word “Georg” selects “George” as a reference destination for “Georg” or associates “Georg” with a user having an ID of “George”. In this case, the learning device 100 determines that “Georg” and “George” tend to be regarded as the same in a certain linguistic area.

In this case, the learning device 100 determines that the user 10 is also likely to have aimed at the user having the ID of “George” as a message transmission destination, and attempts to associate such contents with each other. For example, the learning device 100 outputs a message “Associate “Georg” with “George”?” to the user 10 and waits for a response from the user 10. When the user 10 accepts that “Georg” is associated with “George”, the learning device 100 learns to read “Georg” as “George” in a predetermined voice command. As a result, the user 10 can read a target having the same or similar ID and using a different call as his/her desired call.

Note that in the example illustrated in FIG. 4, for other user who lives in the same linguistic area (in this example, a German speaking area) as the user 10, the learning device 100 may similarly learn to read “Georg” as “George” on the basis of a learning result of the user 10. With such processing, the learning device 100 can eliminate difficulty in reading a language and misreading thereof and specify a target as intended by the user, so that users' interaction between different linguistic areas can be smoothly promoted.

As described above with reference to FIGS. 1 to 4, according to the learning processing according to the embodiment, it is possible to set a call at a low load not only for a user or an application but also for any target.

Note that although FIGS. 1 to 4 illustrate the examples in which the user 10 issues a voice command, the command indicating an instruction to the learning device 100 can be issued, not limited to by voice, by a text, a gesture, a line of sight, a brain wave signal, or the like. Therefore, as the information for specifying a target, the learning device 100 can learn not only a call but also a text, a gesture, a line of sight, a brain wave signal, and the like corresponding to the target as long as the target can be specified.

### 1-2. Configuration of Learning Device According to Embodiment

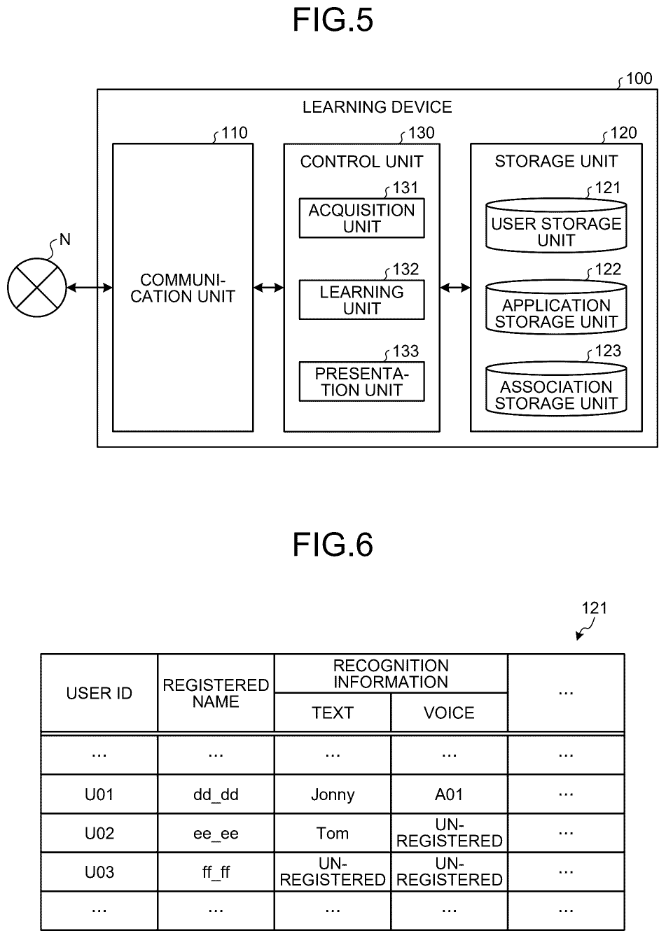

Next, a configuration of the learning device 100 will be described. FIG. 5 is a diagram illustrating a configuration example of the learning device 100 according to the embodiment.

As illustrated in FIG. 5, the learning device 100 includes a communication unit 110, a storage unit 120, and a control unit 130. Note that the learning device 100 may have an input unit (e.g., a keyboard, a mouse, or the like) that receives various operations from a manager or the like who manages the learning device 100, and a display unit (e.g., a liquid crystal display or the like) for displaying various types of information.

The communication unit 110 is realized by, for example, a network interface card (NIC), a network interface controller, or the like. The communication unit 110 is connected to a network N in a wired or wireless manner, and transmits and receives information to and from an external device and the like via the network N. The network N is realized by, for example, a wireless communication standard or system such as Bluetooth (registered trademark), the Internet, Wi-Fi (registered trademark), ultra wide band (UWB), and low power wide area (LPWA).

The storage unit 120 is realized by, for example, a semiconductor memory element such as a random access memory (RAM) or a flash memory, or a storage device such as a hard disk or an optical disk.

The storage unit 120 stores various types of information regarding the learning processing according to the embodiment. In addition, the storage unit 120 stores a learning result such as association between a target and a call. In the embodiment, the storage unit 120 includes a user storage unit 121, an application storage unit 122, and an association storage unit 123. Each storage unit will be sequentially described below with reference to FIGS. 6 to 8.

FIG. 6 is a diagram illustrating an example of the user storage unit 121 according to the embodiment. As illustrated in FIG. 6, the user storage unit 121 includes items such as “user ID”, “registered name”, “recognition information”, “text”, and “voice”. Although in the examples illustrated in FIGS. 6 to 8, data and parameters stored in the storage unit 120 are conceptually shown as “A01” in some cases, each piece of information to be described later is stored in the storage unit 120 in practice.

The “user ID” indicates unique identification information for identifying a user. The “registered name” is a name of a user displayed on the system, such as a handle name, an account ID, and a nickname set by the user.

The “recognition information” is information for use by the system to recognize a user, and is information registered for each user as a result of the learning processing according to the embodiment. The “text” is information indicated as a text (character) among the recognition information. The “voice” is information indicated as voice data among the recognition information. The recognition information may be registered as text, may be registered as voice, or both may be registered. Furthermore, the learning device 100 may cause the user 10 to select information to be registered as the recognition information.

Specifically, the example of FIG. 6 shows that the registered name of a user with a user ID “U01” is “dd_dd”, a text is “Jonny” as the recognition information, and “A01” is registered as voice data corresponding to the text. In this case, in a case where the user 10 has pronounced “Jonny”, the learning device 100 can recognize the user ID “U01” by text conversion of the pronunciation, or can recognize the user ID “U01” on the basis of collation of voice data at the time of pronouncing “Jonny”.

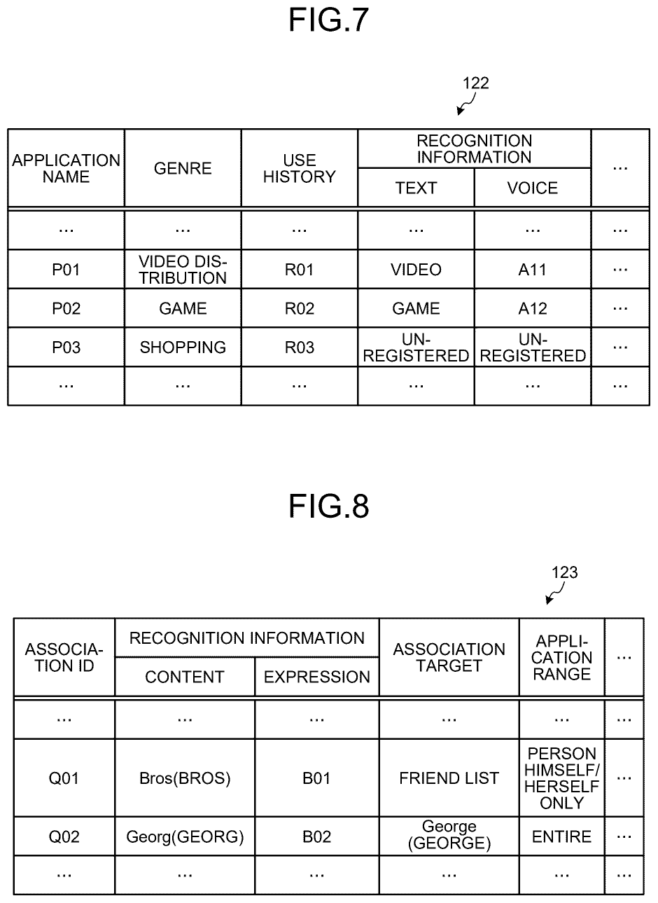

FIG. 7 is a diagram illustrating an example of the application storage unit 122 according to the embodiment. As illustrated in FIG. 7, the application storage unitr 122 includes items such as “application name”, “genre”, “use history”, and “recognition information”.

The “application name” is a name of an application (program) usable in the system of the learning device 100. The “genre” indicates a genre for dividing an application. The “use history” indicates a use history of an application used by the user 10 in the learning device 100. The use history is, for example, name, the number of times, frequency, use time, and the like of the application started by the user 10.

The “recognition information” is information for use by the system to recognize an application, and is information registered for each learning device 100 (in other words, for each user 10 who uses the learning device 100) as a result of the learning processing according to the embodiment. The “text” is information indicated as a text (character) among the recognition information. The “voice” is information indicated as voice data among the recognition information. The recognition information may be registered as text, may be registered as voice, or both may be registered. Furthermore, the learning device 100 may cause the user 10 to select information to be registered as the recognition information.

Specifically, the example of FIG. 7 shows that the application having the application name “P01” has the genre of “video distribution” and the use history of “R01”, and as the recognition information, the text is “video” and voice data corresponding to the text is registered as “All”. In this case, when the user 10 pronounces “video”, the learning device 100 can recognize the application with the application name “P01” by text conversion of the pronunciation, or recognize the application with the application name “P01” on the basis of the collation of voice data at the time of pronouncing “video”.

FIG. 8 is a diagram illustrating an example of the association storage unitr 123 according to the embodiment. As illustrated in FIG. 8, the association storage unitr 123 includes items such as “association ID”, “recognition information”, “expression”, “text/voice”, “association target”, and “application range”.

The “association ID” is identification information for identifying a target with which some association has been made by the learning device 100. The “recognition information” is information for the system to recognize an original target to be associated. The “content” is information indicating a content of a target to be recognized. The “expression” is a character string, voice data, a gesture, a brain wave signal, or the like for expressing (specifying) a target to be recognized. In the example of FIG. 8, “B01” corresponds, for example, to a character string of “Bros” or voice data in a case where the user 10 pronounces “Bros”.

The “association target” indicates a target of the other party with which the target indicated by the recognition information is associated. Note that the item “association target” may include text, voice data, or the like for specifying the target to be associated. The “application range” indicates a range to which the association is applied. For example, in a case where the application range is “the person himself/herself only”, the association is applied to an individual user 10 who uses the learning device 100. Alternatively, in a case where the application range is “entire”, the association is applied to the entire user who uses the system of the learning device 100. Note that the application range may be set for each attribute of a user who uses the system, such as a country or a residential area in which the system is used.

Specifically, in one example in FIG. 8, association with an association ID “Q01” indicates that the content of the recognition information is “Bros”, the content is expressed by “B01”, the recognition information is associated with the “friend list”, and the application range thereof is “the person himself/herself only”. Specifically, when recognizing the expression uttered by the user 10 as “Bros”, the learning device 100 determines that “Bros” indicates the “friend list” on the basis of the association.

Furthermore, in other example in FIG. 8, association with an association ID “Q02” indicates that the content of the recognition information is “Georg”, the content is expressed by “B02”, the recognition information is associated with “George”, and the application range thereof is “entire”. Specifically, when recognizing an expression uttered by a certain user as “Georg”, the learning device 100 determines that “Georg” is aimed at by the user, including a target recognized by “George”, on the basis of such association. For example, when searching the ID of “Georg”, the learning device 100 may search ID including the ID of “George”.

Returning to FIG. 5, the description will be continued. The control unit 130 is realized by, for example, a central processing unit (CPU), a micro processing unit (MPU), GPU, or the like executing a program (e.g., a learning program according to the present disclosure) stored in the learning device 100 using a random access memory (RAM) or the like as a work area. Furthermore, the control unit 130 is a controller, and may be realized by, for example, an integrated circuit such as an application specific integrated circuit (ASIC) or a field programmable gate array (FPGA).

As illustrated in FIG. 5, the control unit 130 includes an acquisition unit 131, a learning unit 132, and a presentation unit 133.

The acquisition unit 131 acquires various types of information. For example, the acquisition unit 131 acquires a content of a command input by the user 10 to a predetermined information processing system to be executed by the learning device 100. The command is a command for the user 10 to cause the learning device 100 to execute some processing. For example, the command is input to the learning device 100 when the user 10 performs some operation in a user interface of an OS provided by the learning device 100. For example, the command may be a voice command based on utterance (voice input) of the user 10, or a command input by text input, by selection of an icon displayed on a user interface, or the like.

In a case where it is determined that an unrecognizable target is included in the command acquired by the acquisition unit 131, the learning unit 132 learns recognition information for recognizing a target on the basis of operation of the system by the user 10 or on a use history of the system. For example, in a case where it is determined that an unrecognizable target is included in the voice command, the learning unit 132 learns a call corresponding to a target on the basis of the operation of the system by the user 10 or on the use history of the system. Note that the call is not necessarily limited to utterance, and may be a character string indicating the call or voice data corresponding to the call.

As an example, the learning unit 132 learns the recognition information as a different expression of the target. Specifically, as illustrated in FIGS. 1 and 2, the learning unit 132 learns, as the recognition information, information indicating a certain target in a different expression, such as calling a certain user as “Jonny” or calling a certain application as “video”.

For example, after determining that a command includes an unrecognizable target, the learning unit 132 learns the recognition information on the basis of information specified by selection operation by the user 10. Specifically, in a case where the command includes an unrecognizable target, the learning unit 132 presents a list or the like corresponding to the command to the user 10. For example, in a case where the target of the command is other user, the learning unit 132 presents the friend list to the user 10. Then, on the basis of operation, by the user 10, of selecting a predetermined user from the list, the learning unit 132 learns the recognition information (a call or the like uttered by the user 10 to designate a predetermined user) as information representing the target.

For example, in a case where the user 10 inputs a voice command, the learning unit 132 learns the recognition information on the basis of information specified by an input means other than utterance by the user 10. Specifically, in a case where a predetermined friend is selected by an input means (controller, keyboard, touch panel, or the like) for selecting a friend list, the learning unit 132 learns a call or the like for designating a predetermined friend as the recognition information.

Alternatively, in a case where it is determined that an unrecognizable target is included in the command, the learning unit 132 estimates a content to be learned as the recognition information on the basis of a use history of the system by the user when an unrecognizable target was detected in the past. For example, as illustrated in FIG. 2, the learning unit 132 estimates what kind of target is meant by the target uttered by the user 10 on the basis of an action frequently taken by the user 10 in the past in a case where a certain target is uttered. For example, in a case where there is a history that after the user 10 uttered “I want to see “video”.”, no voice command was recognized and a video application was manually started, the learning unit 132 learns “video” as recognition information regarding a video application, assuming that “video” means a video application.

The learning unit 132 can use various types of information as a use history. For example, the learning unit 132 can estimate what kind of target is meant by the target uttered by the user 10 on the basis of the number of times a certain target is uttered and then a different target is selected within a predetermined period, the frequency of the selection, and the like.

Note that as illustrated in FIGS. 1 to 4 and the like, when the user 10 instructs to learn specified information as a different expression of a target or to learn to associate a certain target with another target, the learning unit 132 may learn such contents. As a result, the user 10 can prevent the learning device 100 from learning a content that the user does not desire.

Furthermore, as other example of the learning processing, the learning unit 132 may learn the recognition information as information for use to read a target as another target. For example, as illustrated in FIG. 3, the learning unit 132 learns that the utterance of “Bros” by the user 10 means a friend list that is another target. In this case, the recognition information is not only information directly indicating the target but also information associated with other target. For example, the recognition information is information indicating an original target (“Bros” in the example of FIG. 8) and information indicating a target to be associated (the friend list in the example of FIG. 8).

For example, in a case where it is determined that an unrecognizable target is included in the command, the learning unit 132 estimates another target to be associated with the target on the basis of a use history of the system by the user when an unrecognizable target was detected in the past. For example, as illustrated in FIG. 3, the learning unit 132 estimates what kind of target is meant by the target uttered by the user 10 on the basis of an action frequently taken by the user 10 in the past in a case where a certain target is uttered. For example, in a case where there is a history that no voice command was recognized and the friend list was manually opened after the user 10 uttered “Show me “Bros”.”, the learning unit 132 learns to associate “Bros” with the friend list on the assumption that “Bros” is rephrased with the friend list.

Furthermore, in a case where it is determined that an unrecognizable target is included in the command, the learning unit 132 estimates another target to be associated with the target on the basis of a use history of the system by the user 10 or by other user different from the user 10. For example, as illustrated in FIG. 4, in a case where the user 10 utters a certain target, when it is determined that there is a history that many other users associated the target with another target or manually selected the another target after the utterance, the learning unit 132 learns to associate the target uttered by the user 10 with that another target.

Note that also in such an example, in a case where the user 10 instructs to associate the estimated another target with an original target, the learning unit 132 may associate the estimated another target with the original target.

Furthermore, when learning the recognition information, the learning unit 132 may determine in more detail whether a learning content conforms to an intention of the user 10 or not. As an example, in the same user interface layer as the voice command, when information corresponding to a target is specified by an input means other than utterance by the user 10, and the same execution content as the voice command is executed for the specified target, the learning unit 132 may learn a call corresponding to the target.

For example, in a case where the system does not recognize the target in the input of a voice command, the user 10 may return to a top page of the OS or the like from the layer (e.g., a search screen of other user) of the user interface corresponding to the voice command. Even if the user 10 performs some operation thereafter, it is assumed that the operation is less related to the target included in the voice command. In this case, the learning unit 132 attempts not to learn information acquired after the layer of the user interface is changed as the recognition information. Alternatively, even if the user 10 performs some operation of specifying a target after a certain target has not been recognized, when the action is different from the voice command, there is a possibility that the target that has not been recognized is less related to the information specified thereafter. Also in this case, the learning unit 132 attempts not to learn information acquired after the layer of the user interface is changed as the recognition information. As a result, the learning unit 132 can perform learning according to an intention of the user 10.

When recognizing recognition information after the recognition information is learned by the learning unit 132, the presentation unit 133 presents a target corresponding to the recognition information. For example, in a case where the user 10 uttered “Jonny” after “Jonny” was learned as recognition information indicating a predetermined user, the presentation unit 133 presents the predetermined user corresponding to “Jonny” to the user 10. As a result, the user 10 can indicate an aimed target in an expression desired by the user.

Note that in the above-described processing, the command is not limited to a character string or voice, and may be input by various means. In other words, the acquisition unit 131 may acquire a content of a command based on a gesture, a line of sight, or a brain wave signal of the user. In this case, in a case where it is determined that an unrecognizable target is included in the command, the learning unit 132 can learn a gesture, a line of sight, or a brain wave signal corresponding to the target on the basis of operation of the system by the user 10 or a use history of the system.

### 1-3. Procedure of Learning Processing According to Embodiment

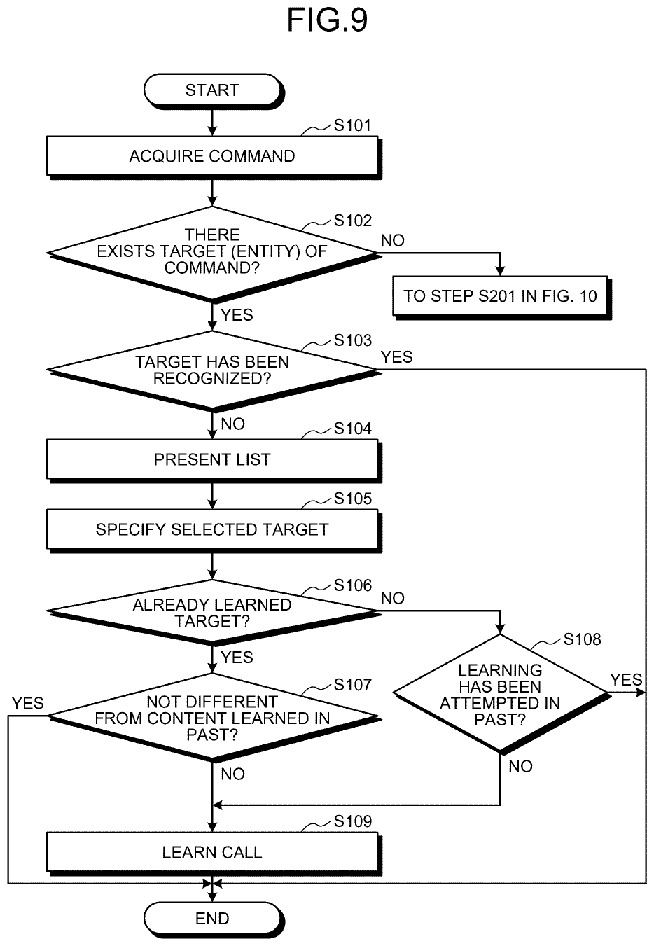

Next, a procedure of the learning processing according to the embodiment will be described with reference to FIGS. 9 to 11. FIG. 9 is a flowchart (1) illustrating a flow of the learning processing according to the embodiment.

As illustrated in FIG. 9, the learning device 100 acquires a command according to voice input or the like by the user 10 (Step S101). At this time, the learning device 100 determines whether there exists a target (entity) of the command or not (Step S102). Note that the command having no target is an instruction having no aim, such as “I want to send a message”.

When there exists no target (Step S102; No), the processing branches to Step S201. When there exists a target (Step S102; Yes), the learning device 100 determines whether or not the target has been recognized (Step S103). When the target has been recognized (Step S103; Yes), the learning device 100 executes the command input by the user 10 and ends the processing.

On the other hand, in a case where the target cannot be recognized (Step S103; No). The learning device 100 presents a list corresponding to the command (Step S104). In a case where the target is selected by the user 10 from the presented list, the learning device 100 specifies the selected target (Step S105).

The learning device 100 determines whether or not the specified target has already been learned (Step S106). For example, the learning device 100 refers to the storage unit 120 and determines whether or not any recognition information is registered for such a selected target.

When it is determined that the target has not been learned (Step S106; No), the learning device 100 determines whether or not learning has been attempted in the past for such a target (Step S108). In a case where learning has been attempted in the past (Step S108; Yes), it is determined that the user 10 does not want to learn such a target, and the learning device 100 ends the processing without learning.

On the other hand, in a case where the specified target has been learned (Step S106; Yes), the learning device 100 determines whether or not information that cannot be recognized this time is different from the recognition information registered for the target (Step S107). When there is no difference from the recognition information registered for the target (Step S107; Yes), the learning device 100 determines that it is not necessary to perform learning this time, and ends the processing without performing learning.

On the other hand, in a case where the recognition information is different from the recognition information registered for the target (Step S107; No), or in a case where the target has not been learned and learning has not been attempted in the past (Step S108; No), the learning device 100 learns, as the recognition information, the call or the like acquired in Step S101 (Step S109).

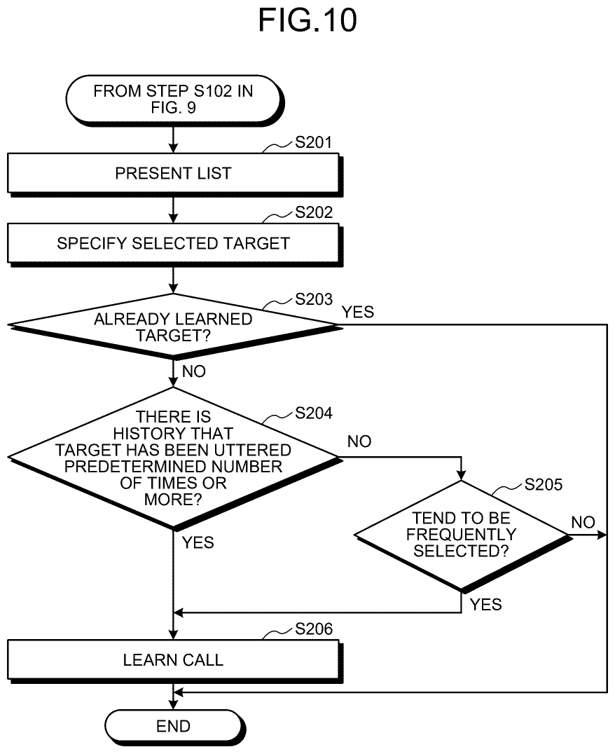

Next, processing branched from FIG. 9 will be described with reference to FIG. 10. FIG. 10 is a flowchart (2) illustrating a flow of the learning processing according to the embodiment.

As illustrated in FIG. 10, when acquiring a command having no target, the learning device 100 presents a list corresponding to the command (Step S201). In a case where the target is selected by the user 10 from the presented list, the learning device 100 specifies the selected target (Step S202).

The learning device 100 determines whether the specified target has already been learned or not (Step S203). For example, the learning device 100 refers to the storage unit 120 and determines whether or not any recognition information is registered for such a selected target. When the target has already been learned (Step S203; Yes), the learning device 100 determines that the learning processing is not required, and ends the processing.

On the other hand, when it is determined that the learning has not been completed (Step S203; No), the learning device 100 determines whether or not there is a history that the selected target has been uttered a predetermined number of times or more (Step S204). In other words, the learning device 100 determines whether the user 10 tries to designate such a target as a target of some operation. This is because it is assumed that the convenience of the user 10 is enhanced by learning with respect to a target (user or the like) that becomes a certain target a large number of times.

In a case where there is no history of utterance made the predetermined number of times or more (Step S204; No), the learning device 100 determines whether or not the target tends to be frequently selected by some input means other than utterance (Step S205). This is also because a target that is selected as a certain target a large number of times is assumed to increase the convenience of the user 10 by learning.

In a case where the target does not tend to be frequently selected (Step S205; No), the learning device 100 determines that the necessity of learning is low, and ends the processing without learning.

On the other hand, in a case where there is a history that the target has been uttered the predetermined number of times or more (Step S204; Yes), or in a case where the target tends to be frequently selected (Step S205; Yes), for the target selected in Step S202, the learning device 100 learns utterance or the like in the history as the recognition information (Step S206).

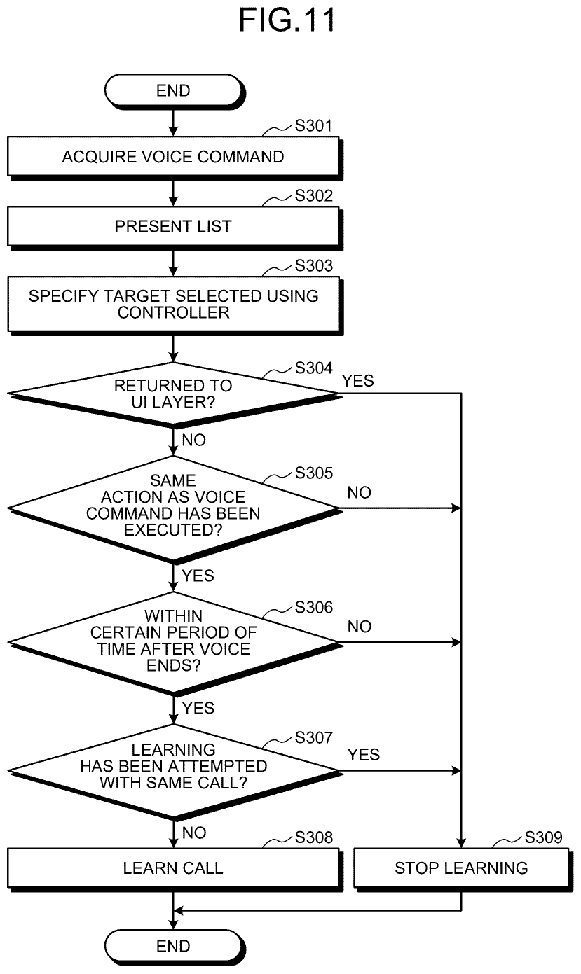

Next, with reference to FIG. 11, details of the processing of determining whether or not to learn a call input by a voice command will be described. FIG. 11 is a flowchart (3) illustrating a flow of the learning processing according to the embodiment. Note that the example of FIG. 11 illustrates a flow of processing in a situation where the learning device 100 has not been able to recognize a target included in a voice command.

The learning device 100 acquires a voice command according to voice input or the like by the user 10 (Step S301). The learning device 100 presents a list corresponding to the command (Step S302). The learning device 100 specifies a target selected by the user 10 using a controller or the like that is an input means different from voice (Step S303).

Thereafter, the learning device 100 determines whether or not it has returned to the UI (user interface) layer on the basis of the operation of the user 10 (Step S304). In a case where returned to the UI layer (Step S304; Yes), i.e., in a case where the user 10 is separated from the user interface opened by the voice command acquired in Step S301, the learning device 100 determines that the necessity of learning the specified target is low and stops the learning (Step S309).

In a case where the processing is continued without changing the UI layer (Step S304; No), the learning device 100 determines whether or not the same action as that instructed by the voice command has been executed on the basis of the instruction of the user 10 (Step S305). When an instruction different from the voice command is issued (Step S305; No), since it is assumed that the target to be learned has changed, the learning device 100 determines that the necessity of learning is low and stops the learning (Step S309).

In a case where the same action as that instructed by the voice command is executed (Step S305; Yes), the learning device 100 determines whether or not the action has been performed within a certain period of time (Step S306). In a case where the action is not executed within the certain period of time (Step S306; No), the learning device 100 determines that the request of the user 10 for learning is low and stops the learning (Step S309).

In a case where the action has been executed within the certain period of time (Step S306; Yes), the learning device 100 determines whether or not learning has been attempted with the same call in the past (Step S307). In a case where learning has been attempted in the past (Step S307; Yes), the learning device 100 determines that the user 10 does not want to learn for such a target, and stops the learning (Step S309).

In a case where learning has not been attempted in the past (Step S307; No), the learning device 100 learns the call acquired in Step S301 as a call (recognition information) corresponding to such a target (Step S308).

As described above, the learning device 100 activates the learning processing only when the user 10 continues the operation with the same intention as the voice command after a shift from the voice operation to the operation by the controller or the like. As a result, the learning device 100 can suppress useless learning processing that does not meet the intention of the user 10.

### 1-4. Modification

### (1-4-1. Device Configuration)

The learning device 100 according to the embodiment merely conceptually shows the functions, and can take various modes according to the embodiments. For example, the learning device 100 may include two or more devices different for each function described above. As an example, the learning device 100 may include a cloud server and an edge terminal (a smart speaker, a smartphone, or the like) connected via a network. In this case, when the edge terminal acquires a voice command, the edge terminal sends the acquired information to the cloud server. Then, the cloud server performs such learning processing as illustrated in FIG. 1, and reflects a learning result in processing executed by the edge terminal.

### (1-4-2. Learning Result)

In the above embodiment, the example has been described in which the learning device 100 stores the result of the learning processing in the user storage unit 121, the application storage unit 122, and the association storage unit 123 illustrated in FIGS. 6 to 8. However, the data tables illustrated in FIGS. 6 to 8 are examples, and are not necessary to store the learning result in such a format. Specifically, the learning device 100 may store a learning result in any form as long as a first expression for specifying an arbitrary target can be associated with a second expression.

Furthermore, the learning device 100 may store not only information associated with the recognition information but also a term or the like (voice input recognized as “Jonny” illustrated in FIG. 1, or the like) that has not been able to specify a target. In other words, the learning device 100 may hold an input history of a term that has become unrecognizable. As a result, the learning device 100 can execute flexible learning processing such as performing learning, for example, only when the same unrecognizable term is input a predetermined number of times.

### (1-4-3. Input to System)

In the above embodiment, the example has been described in which the learning device 100 receives some command input from the user 10. Here, the command input does not necessarily involve execution of the information processing by the system, and may be input of some information to the system. Furthermore, a target to be input is not limited to a user or an application name, and may be arbitrary information such as an item or a character in a game content.

### 2. Other Embodiments

The processing according to each embodiment described above may be performed in various different forms other than each embodiment described above.

Among the processing described in the above embodiments, it is possible to manually perform all or a part of the processing described as being performed automatically, or it is possible to automatically perform, by a known method, all or a part of the processing described as being performed manually. Furthermore, the processing procedures, the specific names, and the information including various types of data and parameters illustrated in the above document and drawings can be arbitrarily changed unless otherwise specified. For example, the various types of information illustrated in the respective drawings are not limited to the illustrated information.

In addition, each component of each device illustrated in the drawings is functionally conceptual, and is not necessarily configured physically as illustrated in the drawings. Specifically, a specific form of distribution and integration of each device is not limited to those illustrated, and all or a part thereof can be functionally or physically distributed and integrated on an arbitrary unit basis according to various loads, use conditions, and the like. For example, the learning unit 132 and the presentation unit 133 may be integrated.

In addition, the above-described embodiments and modifications can be appropriately combined within a range in which the processing contents do not contradict each other.

In addition, the effects described in the present specification are examples only and are not limited, and other effects may be provided.

### 3. Effects of Learning Device According to Present Disclosure

As described above, the learning device (the learning device 100 in the embodiment) according to the present disclosure includes the acquisition unit (the acquisition unit 131 in the embodiment) and the learning unit (the learning unit 132 in the embodiment). The acquisition unit acquires a content of a command input by a user to a predetermined information processing system. In a case where it is determined that an unrecognizable target is included in the command, the learning unit learns recognition information for recognizing the target on the basis of operation of the information processing system by the user or a use history of the information processing system.

As described above, in a case where an input by the user includes an unrecognizable target, the learning device according to the present disclosure automatically assigns recognition information for recognizing the target on the basis of operation by the user or a use history thereof. As a result, the user can easily set information for specifying a predetermined target without a work of manually performing some setting in order to recognize the target.

Furthermore, the learning unit learns the recognition information as a different expression of the target. For example, after determining that the command includes an unrecognizable target, the learning unit learns the recognition information on the basis of the information specified by the selection operation by the user. Alternatively, in a case where it is determined that an unrecognizable target is included in the command, the learning unit estimates a content to be learned as the recognition information on the basis of a use history of the information processing system by the user when the unrecognizable target was detected in the past.

In this manner, the learning device can recognize a certain target in an expression desired by the user by learning, as the recognition information, information in which the target is represented in another expression. As a result, the learning device can improve convenience in the system.

Furthermore, in a case where the user instructs to learn specified information as a different expression of the target, the learning unit learns the specified information as a different expression of the target.

In this manner, since the learning device determines whether or not to perform learning in accordance with an instruction of the user, it is possible to suppress unnecessary learning from being performed.

In addition, the learning unit learns recognition information as information for use to read a target as another target. For example, in a case where it is determined that an unrecognizable target is included in a command, the learning unit estimates another target to be associated with the target on the basis of a use history of the information processing system by the user when the unrecognizable target was detected in the past.

As described above, the learning device may not only learn, as the recognition information, one representing the same target in another expression such as a user's given name, but also learn the recognition information as one representing a different target. As a result, the learning device can recognize various targets with given names desired by the user, and thus, it is possible to improve convenience of the user.

Furthermore, in a case where it is determined that an unrecognizable target is included in the command, the learning unit estimates another target to be associated with the target on the basis of a use history of the information processing system by the user or by other user different from the user.

In this manner, the learning device estimates another target to be associated with a certain target on the basis of not only the user himself/herself who uses the learning device but also collective intelligence of other users, and it is thus possible to accurately associate a target in which a different expression is generated due to, for example, a language difference. As a result, the learning device can recognize an arbitrary target regardless of, for example, a difference in pronunciation due to language and thus can execute accurate information processing according to the user's intention.

Furthermore, in a case where the user instructs to associate estimated another target with a target, the learning unit associates the estimated another target with the target.

In this manner, since the learning device determines whether or not to perform learning in accordance with an instruction of the user, it is possible to suppress unnecessary learning from being performed.

In addition, the acquisition unit acquires a content of the voice command input by the user. In a case where it is determined that an unrecognizable target is included in the voice command, the learning unit learns a call corresponding to the target on the basis of operation of the information processing system by the user or a use history of the information processing system. For example, as a call corresponding to a target, the learning unit learns a character string indicating the call or voice data corresponding to the call.

In this manner, by learning a call related to voice input that is likely to cause a difference depending on a user, the learning device can accurately recognize, for example, a character string that is difficult to pronounce or a target for which how to pronounce is unknown.

Furthermore, when it is determined that a voice command includes an unrecognizable target, the learning unit learns, as the recognition information, information specified by an input means other than utterance by the user.

As described above, since the learning device associates a target that cannot be recognized by utterance with a target selected by the subsequent controller operation or the like by the user, it is possible to perform learning according to the intention of the user.

Furthermore, in the same user interface layer as the voice command, when information corresponding to a target is specified by an input means other than utterance by the user, and the same execution content as the voice command is executed for the specified target, the learning unit learns a call corresponding to the target.

As described above, since the learning device determines whether or not to perform learning on the basis of the action of the user in the system, it is possible to more accurately perform learning according to the intention of the user.

Furthermore, the learning device may further include the presentation unit that presents, when recognition information is recognized after the recognition information is learned by the learning unit, a target corresponding to the recognition information.

As described above, by executing the information processing reflecting a learning result, the learning device can provide a system optimized in accordance with utterance or action of the user without user's manual setting or the like.

In addition, the acquisition unit acquires a content of a command based on at least one of a gesture, a line of sight, and a brain wave signal of the user. In a case where it is determined that an unrecognizable target is included in the command, the learning unit learns at least one of a gesture, a line of sight, and a brain wave signal of the user corresponding to the target on the basis of operation of the information processing system by the user or a use history of the information processing system.

As described above, since the learning device can learn a target recognized on the basis of various input means without using voice or the like, convenience of the user can be improved in information processing devices of various forms.

### 4. Hardware Configuration

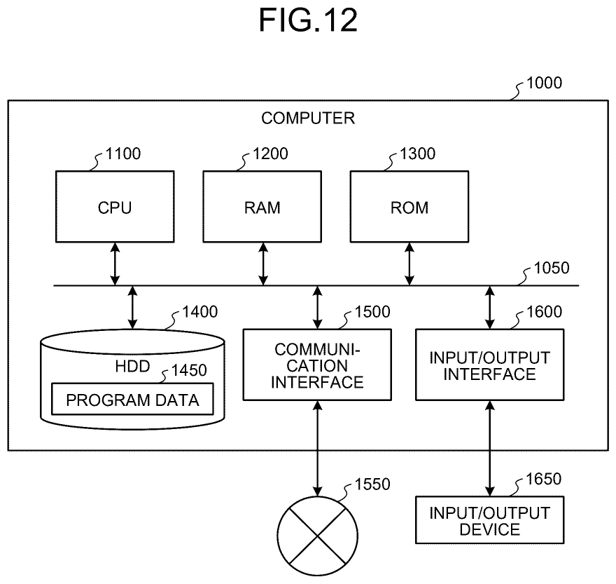

Information apparatuses such as the learning devices 100 according to the embodiments described above and the like are realized by a computer 1000 having such a configuration as illustrated in FIG. 12, for example. In the following, description will be made of the learning device 100 as an example. FIG. 12 is a hardware configuration diagram illustrating an example of the computer 1000 that implements the functions of the learning device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates to control each unit on the basis of a program stored in the ROM 1300 or the HDD 1400. For example, the CPU 1100 develops the program stored in the ROM 1300 or in the HDD 1400 into the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data for use by such program, and the like. Specifically, the HDD 1400 is a recording medium that records a learning program according to the present disclosure as an example of program data 1450.

The communication interface 1500 is an interface for the computer 1000 to connect to an external network 1550 (e.g., the Internet). For example, the CPU 1100 receives data from other apparatus or transmits data generated by the CPU 1100 to other apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, an edge, or a printer via the input/output interface 1600. In addition, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the learning device 100 according to the embodiment, the CPU 1100 of the computer 1000 implements the functions of the control unit 130 and the like by executing the learning program loaded on the RAM 1200. In addition, the HDD 1400 stores the learning program according to the present disclosure and data in the storage unit 120. Note that although the CPU 1100 reads the program data 1450 from the HDD 1400 and executes the program data, as other example, the programs may be acquired from other device via the external network 1550.

Note that the present technique can also have the following configurations.
(1) A learning device comprising:
   an acquisition unit that acquires a content of a command input by a user to a predetermined information processing system; and
   a learning unit that in a case where it is determined that the command includes an unrecognizable target, learns recognition information for recognizing the target on the basis of operation of the information processing system by the user or a use history of the information processing system.
(2) The learning device according to (1), wherein
   the learning unit
   learns the recognition information as a different expression of the target.
(3) The learning device according to (2), wherein
   the learning unit,
   after it is determined that the command includes an unrecognizable target, learns the recognition information on the basis of information specified by selection operation by the user.
(4) The learning device according to (2) or (3), wherein
   the learning unit,
in a case where it is determined that the command includes an unrecognizable target, estimates a content to be learned as the recognition information on the basis of a use history of the information processing system by the user when the unrecognizable target has been detected in the past.
(5) The learning device according to (3) or (4), wherein
   the learning unit,
   in a case where the user instructs to learn the specified information as a different expression of the target, learns the specified information as a different expression of the target.
(6) The learning device according to any one of (1) to (5), wherein
   the learning unit
   learns the recognition information as information for use to read the target as another target.
(7) The learning device according to (6), wherein
   the learning unit,
   in a case where it is determined that the command includes an unrecognizable target, estimates the another target to be associated with the target on the basis of a use history of the information processing system by the user when the unrecognizable target has been detected in the past.
(8) The learning device according to (6) or (7), wherein
   the learning unit,
   in a case where it is determined that the command includes an unrecognizable target, estimates the another target to be associated with the target on the basis of a use history of the information processing system by the user or by other user different from the user.
(9) The learning device according to (7) or (8), wherein
   the learning unit,
   in a case where the user instructs to associate the estimated another target with the target, associates the estimated another target with the target.
(10) The learning device according to any one of (1) to (9), wherein
   the acquisition unit
   acquires a content of a voice command input by the user, and
   the learning unit,
   in a case where it is determined that the voice command includes an unrecognizable target, learns a call corresponding to the target on the basis of operation of the information processing system by the user or a use history of the information processing system.
(11) The learning device according to (10), wherein
   the learning unit,
   as a call corresponding to the target, learns a character string indicating the call or voice data corresponding to the call.
(12) The learning device according to (10) or (11), wherein
   the learning unit,
   in a case where it is determined that the voice command includes an unrecognizable target, learns information specified by an input means other than utterance by the user as the recognition information.
(13) The learning device according to (12), wherein
   the learning unit,
   in the same user interface layer as the voice command, in a case where information corresponding to the target is specified by an input means other than utterance by the user, and the same execution content as the voice command is executed for the specified target, learns a call corresponding to the target.
(14) The learning device according to any one of (1) to (13), further comprising:
   a presentation unit that in a case where recognition information is learned by the learning unit and then the recognition information is recognized, presents the target corresponding to the recognition information.
(15) The learning device according to any one of (1) to (14), wherein
   the acquisition unit
   acquires a content of the command based on at least one of a gesture, a line of sight, and a brain wave signal of the user, and
   the learning unit,
   in a case where it is determined that the command includes an unrecognizable target, learns at least one of a gesture, a line of sight, and a brain wave signal of the user corresponding to the target on the basis of operation of the information processing system by the user or a use history of the information processing system.
(16) A learning method comprising:
   by a computer,
   acquiring a content of a command input by a user to a predetermined information processing system; and
   learning, in a case where it is determined that the acquired command includes an unrecognizable target, recognition information for recognizing the target on the basis of operation of the information processing system by the user or a use history of the information processing system.

### REFERENCE SIGNS LIST

10 USER
100 LEARNING DEVICE
110 COMMUNICATION UNIT
120 STORAGE UNIT
121 USER STORAGE UNIT
122 APPLICATION STORAGE UNIT
123 ASSOCIATION STORAGE UNIT
130 CONTROL UNIT
131 ACQUISITION UNIT
132 LEARNING UNIT
133 PRESENTATION UNIT

1. A learning device comprising:
an acquisition unit that acquires a content of a command input by a user to a predetermined information processing system; and
a learning unit that in a case where it is determined that the command includes an unrecognizable target, learns recognition information for recognizing the target on the basis of operation of the information processing system by the user or a use history of the information processing system.

2. The learning device according to claim 1, wherein
the learning unit
learns the recognition information as a different expression of the target.

3. The learning device according to claim 2, wherein
the learning unit,
after it is determined that the command includes an unrecognizable target, learns the recognition information on the basis of information specified by selection operation by the user.

4. The learning device according to claim 2, wherein
the learning unit,
in a case where it is determined that the command includes an unrecognizable target, estimates a content to be learned as the recognition information on the basis of a use history of the information processing system by the user when the unrecognizable target has been detected in the past.

5. The learning device according to claim 3, wherein
the learning unit,
in a case where the user instructs to learn the specified information as a different expression of the target, learns the specified information as a different expression of the target.

6. The learning device according to claim 1, wherein
the learning unit
learns the recognition information as information for use to read the target as another target.

7. The learning device according to claim 6, wherein
the learning unit,
in a case where it is determined that the command includes an unrecognizable target, estimates the another target to be associated with the target on the basis of a use history of the information processing system by the user when the unrecognizable target has been detected in the past.

8. The learning device according to claim 6, wherein
the learning unit,
in a case where it is determined that the command includes an unrecognizable target, estimates the another target to be associated with the target on the basis of a use history of the information processing system by the user or by other user different from the user.

9. The learning device according to claim 7, wherein
the learning unit,
in a case where the user instructs to associate the estimated another target with the target, associates the estimated another target with the target.

10. The learning device according to claim 1, wherein
the acquisition unit
acquires a content of a voice command input by the user, and
the learning unit,
in a case where it is determined that the voice command includes an unrecognizable target, learns a call corresponding to the target on the basis of operation of the information processing system by the user or a use history of the information processing system.

11. The learning device according to claim 10, wherein
the learning unit,
as a call corresponding to the target, learns a character string indicating the call or voice data corresponding to the call.

12. The learning device according to claim 10, wherein
the learning unit,
in a case where it is determined that the voice command includes an unrecognizable target, learns information specified by an input means other than utterance by the user as the recognition information.

13. The learning device according to claim 12, wherein
the learning unit,
in the same user interface layer as the voice command, in a case where information corresponding to the target is specified by an input means other than utterance by the user, and the same execution content as the voice command is executed for the specified target, learns a call corresponding to the target.

14. The learning device according to claim 1, further comprising:
a presentation unit that in a case where recognition information is learned by the learning unit and then the recognition information is recognized, presents the target corresponding to the recognition information.

15. The learning device according to claim 1, wherein
the acquisition unit
acquires a content of the command based on at least one of a gesture, a line of sight, and a brain wave signal of the user, and
the learning unit,
in a case where it is determined that the command includes an unrecognizable target, learns at least one of a gesture, a line of sight, and a brain wave signal of the user corresponding to the target on the basis of operation of the information processing system by the user or a use history of the information processing system.

16. A learning method comprising:
by a computer,
acquiring a content of a command input by a user to a predetermined information processing system; and
learning, in a case where it is determined that the acquired command includes an unrecognizable target, recognition information for recognizing the target on the basis of operation of the information processing system by the user or a use history of the information processing system.
